(19) United States
(12) Patent Application Publication
(10) Pub. No.: US 2013/0047005 A1
(43) Pub. Date: Feb. 21, 2013

(54) APPARATUS AND METHOD FOR MANAGING POWER IN A PORTABLE TERMINAL

(71) Applicant: Do-Hyung LEE, Seoul (KR)

(72) Inventor: Do-Hyung LEE, Seoul (KR)

(73) Assignee: SAMSUNG ELECTRONICS CO., LTD., Gyeonggi-do (KR)

(21) Appl. No.: 13/589,806

(22) Filed: Aug. 20, 2012

(30) Foreign Application Priority Data
Aug. 19, 2011 (KR) 10-2011-0082961

(51) Int. Cl. G06F 1/26

(52) U.S. Cl. 713/300

(57) ABSTRACT

A method and apparatus for managing power in a portable terminal are provided, in which a display is provided and upon execution of a power management function to manage power of a Central Processing Unit (CPU) according to a user request, a power manager sets the CPU to a setting mode selected by a user from among a CPU core setting mode for turning-on or turning-off of at least one core included in the CPU, a CPU clock setting mode for setting a clock frequency of the CPU, and a CPU use setting mode for setting the CPU to one of a plurality of pre-determined modes.

### CLAIM OF PRIORITY

This application claims, under 35 U.S.C. §119(a), priority to, and the benefit of the earlier filing date of, that patent application filed in the Korean Intellectual Property Office on Aug. 19, 2011 and assigned Serial No. 10-2011-0082961, the contents of which are incorporated herein by reference.

### BACKGROUND OF THE INVENTION

1. Field of the Invention

The present invention relates to a portable terminal and more particularly, to an apparatus and method for managing power in a portable terminal.

2. Description of the Related Art

Portable terminals, such as smart phones and tablet PCs, provide a variety of useful functions to users through various applications. Owing to the various functions, portable terminals are capable of providing additional various types of information beyond the traditional voice call function.

As a portable terminal is equipped with diverse functions, its user uses the portable terminal more often, thus consuming more power. As a result, the user of the portable terminal is required to recharge or replace the battery more often because of the increased power consumption.

Accordingly, there exists a need for a technique for minimizing the power consumption of a portable terminal.

### SUMMARY OF THE INVENTION

An aspect of embodiments of the present invention is to address at least the problems and/or disadvantages and to provide at least the advantages described below. Accordingly, an aspect of embodiments of the present invention is to provide a method and apparatus for managing the power of a Central Processing Unit (CPU) of a portable terminal by enabling a user to directly set characteristics or operating states of the CPU.

Another aspect of embodiments of the present invention is to provide a method and apparatus for managing the power of a CPU by enabling a user to directly set a processing core (hereinafter, core) included in the CPU to an on-state or an off-state.

A further aspect of embodiments of the present invention is to provide a method and apparatus for managing the power of a CPU by enabling a user to directly change a clock frequency of the CPU.

In accordance with an embodiment of the present invention, there is provided an apparatus for managing power in a portable terminal, in which a display is included and upon execution of a power management function to manage power of a Central Processing Unit (CPU) according to a user request, a power manager sets the CPU to a setting mode selected by a user from a group consisting of: a CPU core setting mode for turning-on or turning-off of at least one core included in the CPU, a CPU clock setting mode for setting a clock frequency of the CPU, and a CPU use setting mode for setting the CPU to one of a plurality of preset modes.

In accordance with another embodiment of the present invention, there is provided a method for managing power in a portable terminal, in which it is determined whether a power management function for managing power of a CPU is executed according to a user request and upon execution of the power management function, the CPU is set to a setting mode selected by a user from a group consisting of: a CPU core setting mode for turning-on or turning-off at least one core included in the CPU, a CPU clock setting mode for setting a clock frequency of the CPU, and a CPU use setting mode for setting the CPU to one of a plurality of preset modes.

### BRIEF DESCRIPTION OF THE DRAWINGS

The above and other objects, features and advantages of certain embodiments of the present invention will be more apparent from the following detailed description taken in conjunction with the accompanying drawings, in which:

FIG. 1 is a block diagram of a portable terminal according to an embodiment of the present invention;

FIGS. 2A, 2B and 2C are flowcharts illustrating a power management operation of the portable terminal according to an embodiment of the present invention;

FIG. 3 illustrates a power management screen in the portable terminal according to an embodiment of the present invention;

FIG. 4 illustrates a power management screen in the portable terminal according to another embodiment of the present invention;

FIG. 5 illustrates a power management screen in the portable terminal according to a further embodiment of the present invention; and

FIG. 6 is a graph illustrating the power consumption of the portable terminal according to an embodiment of the present invention.

Throughout the drawings, the same drawing reference numerals will be understood to refer to the same elements, features and structures.

### DETAILED DESCRIPTION OF THE INVENTION

Reference will be made to preferred embodiments of the present invention with reference to the attached drawings. A detailed description of a generally known function and structure of the present invention will be avoided lest it should obscure the subject matter of the present invention.

According to embodiments of the present invention, the term “portable terminal” refers to a mobile electronic device that can be easily carried by a user, covering a broad range of terminals such as a video phone, a portable phone, a smart phone, an International Mobile Telecommunication 2000 (IMT-2000) terminal, a Wideband Code Division Multiple Access (WCDMA) terminal, a Universal Mobile Telecommunication System (UMTS) terminal, a Personal Digital Assistant (PDA), a Portable Multimedia Player (PMP), a Digital Multimedia Broadcasting (DMB) terminal, an e-book reader, a portable computer (e.g. a laptop or a tablet PC), a digital camera, etc.

Also, terms described herein, which are defined considering the functions of the present invention, may be implemented differently depending on user and operator's intention and practice. Therefore, the terms should be understood on the basis of the disclosure throughout the specification. The principles and features of this invention may be employed in varied and numerous embodiments without departing from the scope of the invention.

Furthermore, although the drawings represent exemplary embodiments of the invention, the drawings are not necessarily to scale and certain features may be exaggerated or omitted in order to more clearly illustrate and explain the present invention.

Among the terms set forth herein, a mobile or portable terminal or terminal refers to any kind of device capable of processing data that is transmitted or received to or from any external entity. The terminal may display icons or menus on a screen to which stored data and various executable functions are assigned or mapped. The terminal may represent a computer, a notebook, a tablet PC, a mobile device, and the like.

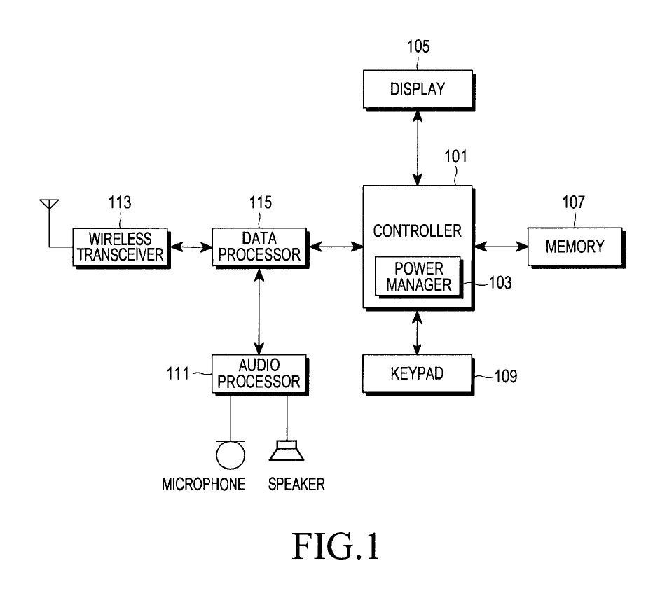

FIG. 1 is a block diagram of a portable terminal according to an embodiment of the present invention.

Referring to FIG. 1, the portable terminal includes a controller 101, a display 105, a memory 107, a keypad 109, an audio processor 111, a wireless transceiver 113, and a data processor 115.

The wireless transceiver 113 takes charge of a wireless communication function of the portable terminal. Specifically, the wireless transceiver 113 includes a wireless transmitter (not shown) for up-converting the frequency of a transmission signal and amplifying the up-converted transmission signal and a wireless receiver (not shown) for low-noise-amplifying a received signal and downconverting the frequency of the low-noise-amplified signal. The data processor 115 includes a transmitter (not shown) for encoding and modulating the transmission signal and a receiver (not shown) for demodulating and decoding the received signal. The data processor 111 may be configured with a MODEM and a CODEC. The CODEC may include a data CODEC for processing packet data and an audio CODEC for processing an audio signal such as voice.

The audio processor 111 reproduces an audio signal received from the data processor 115 and outputs the received signal through a speaker. Similarly, the audio processor 111 may receive an audio signal from a microphone and transmit the received audio signal to the data processor 115. The keypad 109 has alphanumerical keys (not shown) for inputting numbers and characters and function keys for setting functions. The display 105 displays a video signal on a screen and displays data upon request of the controller 101.

If the display 105 is configured as a capacitive or resistive touch screen, the keypad 109 may have a predetermined minimum number of keys and the display 105 may represent all or a part of a key input function of the key pad 109. The present invention is based on the assumption that the display 105 is configured as a touch screen and thus, inputs may be provided in response to information provided on the display 109.

The memory 107 includes a program memory (not shown) and a data memory (not shown). The program memory stores a booting program and Operating System (OS) that controls general operations of the portable terminal, and the data memory stores data generated during operations of the portable terminal.

The controller 101 provides overall control to the portable terminal Particularly, a power manager 103 of the controller 101 manages the power of a Central Processing Unit (CPU) that constitutes the processing center of the controller 101. The CPU may be constructed with one or more processing cores.

More specifically, the power manager 103 determines whether a user has requested a power management function. Upon receipt of a user request for the power management function, the power manager 103 displays a power management mode menu. The power management mode menu may include menu items for a CPU core setting mode, a CPU clock setting mode, and a CPU use setting mode. A processing core included in the CPU is turned-on or turned-off in the CPU core setting mode, the clock frequency of the CPU is changed in the CPU clock setting mode, and the CPU is set to a use mode selected from among a plurality of preset use modes by a user in the CPU use setting mode.

The CPU use setting mode is divided into a high-performance mode, a normal mode, a low-power mode, and a user setting mode. The high-performance mode refers to a mode that maximizes the power consumption of the CPU by turning on all CPU processing cores and changing the clock frequency of the CPU to a highest frequency. The low-power mode is a mode that minimizes the power consumption of the CPU by turning-on only one CPU processing core and changing the CPU clock frequency to a lowest frequency. The normal mode consumes power less than the high-performance mode and greater than the low-power mode by turning-on only a pre-determined number of a total number of CPU cores. For example, one-half of the number of processing cores may be turned-on and the remaining one-half of the number of processing cores may be turned-off in the normal mode. The user setting mode is a mode that turns-on or turns-off a CPU core or changes the CPU clock frequency according to a user request.

The power manager 103 determines a user-selected mode from among the CPU core setting mode, the CPU clock setting mode, and the CPU use setting mode in a power management mode menu. Upon user selection of the CPU core setting mode, the power manager 103 displays a screen for the CPU core setting mode. The CPU core setting mode screen displays the current states of all cores included in the CPU.

For example, if the CPU has four processing cores, the power manager 103 may display the state of each of the four cores. Herein, the power manager 103 may display the on- or off-states of the CPU cores and the current clock frequency of the CPU.

The power manager 103 determines whether the user has requested the on-state or off-state of at least one CPU core. Upon receipt of a user request for turn-on or turn-off of a CPU core, the power manager 103 turns on or off the corresponding CPU core. For example, if the CPU includes four cores and the user requests turn-off of the third CPU core, the power manager 103 may turn off the third CPU core.

The power manager 103 determines whether the user has requested termination of the CPU core setting mode. Upon receipt of a user request for termination of the CPU core setting mode, the power manager 103 ends the power management function by terminating the CPU core setting mode. On the other hand, if the user has not requested termination of the CPU core setting mode, the power manager 103 displays the CPU core setting mode screen.

Upon receipt of a user request for the CPU clock setting mode, the power manager 103 displays a screen for the CPU clock setting mode. The CPU clock setting mode screen displays the current state of all processing cores included in the CPU.

For example, if the CPU includes four cores, the power manager 103 may display the states of the four respective cores. That is, the power manager 103 may display the on- or off-states of the CPU cores and the current clock frequency of the CPU.

The power manager 103 determines whether the user has requested changing of the CPU clock frequency. Upon receipt of a user request for changing the CPU clock frequency, the power manager 103 changes the CPU clock frequency. For example, if the user requests changing of the current clock frequency from 400 MHz to 200 MHz, the power manager 103 may change the current clock frequency from 400 MHz to 200 MHz for all the CPU cores that are turned-on.

The power manager 103 determines whether the user has requested termination of the CPU clock setting mode. Upon receipt of a user request for termination of the CPU clock setting mode, the power manager 103 ends the power management function by terminating the CPU clock setting mode. On the other hand, if the user has not requested termination of the CPU clock setting mode, the power manager 103 displays the CPU clock setting mode screen.

Upon receipt of a user request for the CPU use setting mode, the power manager 103 displays a screen for the CPU use setting mode. The CPU use setting mode screen may display icons or characters representing different pre-determined operational modes (e.g., one or more of a high-performance mode, a normal mode, a low-power mode, and a user setting mode).

The power manager 103 determines a user-selected mode from among the pre-determined operations modes (e.g., a high-performance mode, a normal mode, a low-power mode, and a user setting mode).

Upon receipt of a user request for the high-performance mode, for example, the power manager 103 sets the CPU to the high-performance mode that maximizes the power consumption of the CPU. Specifically, the power manager 103 turns on all CPU processing cores and changes the CPU clock frequency to a highest frequency. For example, if the CPU includes four cores and a highest CPU clock frequency is 400 MHz, the power manager 103 may turn on all four CPU cores and change the current CPU clock frequency to 400 MHz.

Upon receipt of a user request for the normal mode, the power manager 103 turns on selected ones of the CPU cores and turns off the other CPU cores. For example, if the CPU includes four cores, the power manager 103 may turn-on two CPU cores and turn off the other two CPU cores.

Upon receipt of a user request for the low-power mode, the power manager 103 turns on one of the CPU cores and changes the CPU clock frequency to a lowest frequency. For example, if the CPU includes four cores and a lowest CPU clock frequency is 200 MHz, the power manager 103 may turn on one CPU core, while turning off the other three CPU cores and may change the current CPU clock frequency to 200 MHz.

Upon receipt of a user request for the user setting mode, the power manager 103 displays a screen for the user setting mode. The user setting mode screen displays the current states of the respective CPU cores and allows the user to set the CPU on their own.

The power manager 103 determines whether the user has requested turn-on or turn-off of a CPU core or a change of the CPU clock frequency. Upon receipt of a user request to turn-on or turn-off of a CPU core, the power manager 103 turns-on or turns-off a selected CPU core. On the other hand, if the user has requested changing of the CPU clock frequency, the power manager 103 changes the CPU clock frequency according to the user request.

The power manager 103 determines whether the user has requested termination of the CPU use setting mode. Upon receipt of a user request for termination of the CPU use setting mode, the power manager 103 ends the power management function by terminating the CPU use setting mode. However, if the user has not requested termination of the CPU use setting mode, the power manager 103 continues to display the CPU use setting mode screen.

When the power management function ends, the power manager 103 continues the execution of an on-going application according to the current CPU setting state. Upon receipt of a user request for executing the application later, the power manager 103 executes the application according to the current CPU setting state.

The power manager 103 further monitors power consumption according to the current CPU setting state and stores information about the monitored power consumption in a database. Upon receipt of a user request for outputting a power consumption monitoring result, the power manager 103 displays the power consumption recorded in the database as a graph on the display 105.

While the power manager 103 is shown in FIG. 1 as incorporated into the controller 101, it may be further contemplated that the power manager 103 is configured separately from the controller 101.

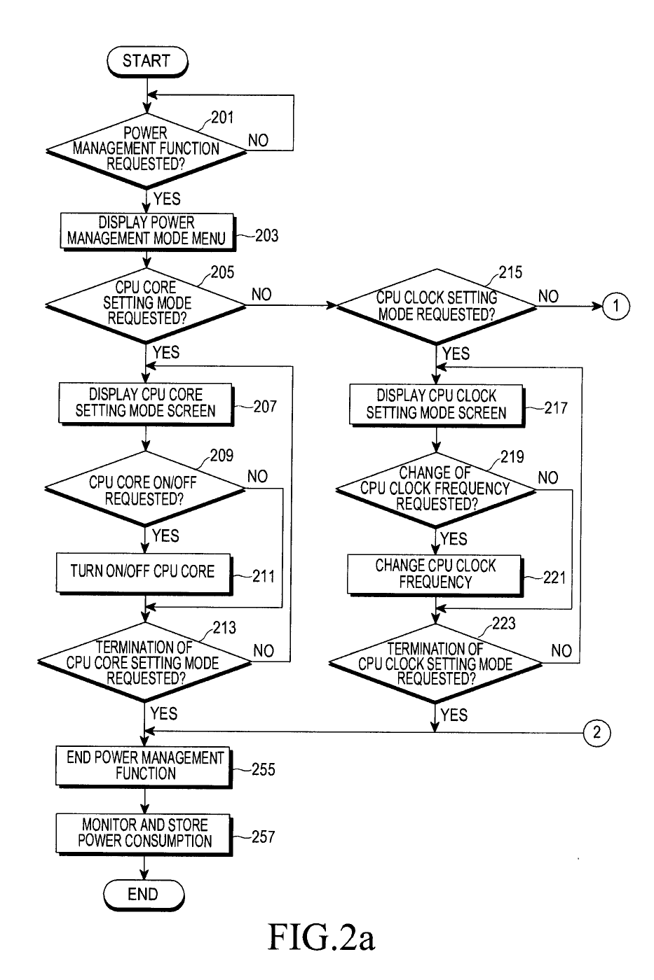

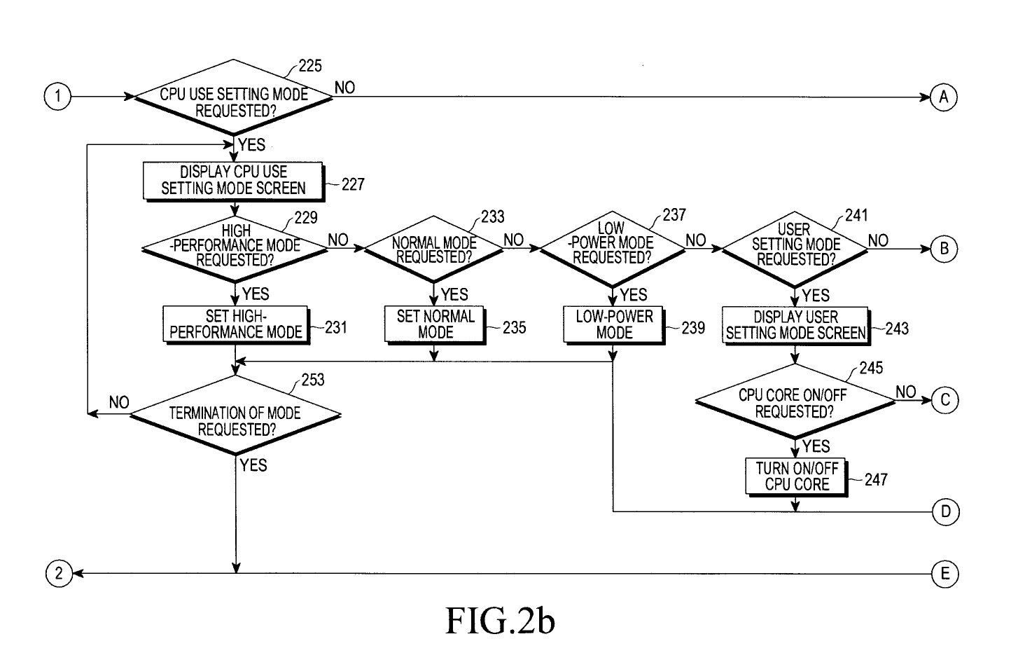

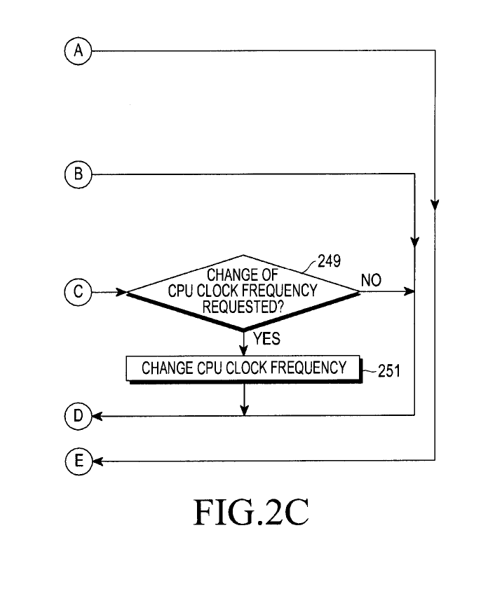

FIGS. 2A, 2B and 2C are flowcharts illustrating a power management operation of the portable terminal according to an embodiment of the present invention.

Referring to FIGS. 2A, 2B and 2C, the power manager 103 monitors receipt of a user request for the power management function in step 201. Upon receipt of a user request for the power management function, the power manager 103 proceeds to step 203. Otherwise, the power manager 103 repeats step 201.

The power manager 103 displays the power management mode menu in step 203 and proceeds to step 205.

The power management mode menu may include menu items for the CPU core setting mode, the CPU clock setting mode, and the CPU use setting mode. The CPU core setting mode is a mode in which a CPU core is turned-on or turned-off. The CPU clock setting mode is a mode in which the clock frequency of the CPU is changed. The CPU use setting mode is a mode in which the CPU is set to a user-selected use mode from among preset use modes.

In one aspect of the invention, the CPU use setting mode includes at least a high-performance mode, a normal mode, a low-power mode, and a user setting mode. All CPU cores are turned on and the CPU clock frequency is changed to a highest frequency in the high-performance mode. In the low-power mode, only one of the CPU cores is turned on and the CPU clock frequency is changed to a lowest frequency. A CPU core is turned on or off or the CPU clock frequency is changed according to a user request in the user setting mode.

In step 205, the power manager 103 monitors receipt of a user request for the CPU core setting mode. Upon user selection of the CPU core setting mode, the power manager 103 proceeds to step 207. Otherwise, the power manager 103 proceeds to step 215.

The power manager 103 displays a screen for the CPU core setting mode in step 207 and proceeds to step 209. The CPU core setting mode screen displays the current states of all CPU cores. For example, if the CPU includes four cores, the power manager 103 may display the states of the four cores. Herein, the power manager 103 may indicate whether the CPU cores are in the turned-on or turned-off-states and indicate the current clock frequency of the CPU.

In step 209, the power manager 103 monitors receipt of a user request to turn-on or turn-off of at least one CPU core. Upon receipt of a user request to turn-on or turn-off of a CPU core, the power manager 103 proceeds to step 211. Otherwise, the power manager 103 proceeds to step 213.

The power manager 103 turns on or off the CPU core in step 211 and goes to step 213. For example, if the CPU includes four cores and the user requests turn-off of a third CPU, the power manager 103 turns off the third CPU core.

In step 213, the power manager 103 determines whether the user has requested termination of the CPU core setting mode. Upon receipt of a user request for termination of the CPU core setting mode, the power manager 103 proceeds to step 255. After termination of the CPU core setting mode, power consumption is monitored and stored at step 257.

Otherwise, the power manager 103 returns to step 207.

Returning to step 205, if the user has failed to request a CPU core setting mode, the power manager 103 monitors receipt of a user request for the CPU clock setting mode in step 215. Upon receipt of a user request for the CPU clock setting mode, the power manager 103 proceeds to step 217. Otherwise, the power manager 103 proceeds to step 225 (see FIG. 2B).

The power manager 103 displays a screen for the CPU clock setting mode in step 217 and proceeds to step 219. The CPU clock setting mode screen displays the current state of all processing cores included in the CPU. For example, if the CPU includes four cores, the power manager 103 may display the states of the four cores. That is, the power manager 103 may display the on- or off-states of the CPU cores and the current clock frequency of the CPU.

In step 219, the power manager 103 determines whether the user has requested changing of the CPU clock frequency. Upon receipt of a user request for changing the CPU clock frequency, the power manager 103 proceeds to step 221. Otherwise, the power manager 103 proceeds to step 223.

The power manager 103 changes the CPU clock frequency in step 221 and proceeds to step 223. For example, if the user requests changing of the current clock frequency from 400 MHz to 200 MHz, the power manager 103 changes the current clock frequency from 400 MHz to 200 MHz.

In step 223, the power manager 103 determines whether the user has requested termination of the CPU clock setting mode. Upon receipt of a user request for termination of the CPU clock setting mode, the power manager 103 proceeds to step 255. Otherwise, the power manager 103 proceeds to step 217.

Meanwhile, the power manager 103 monitors receipt of a user request for the CPU use setting mode in the power management mode menu in step 225. Upon receipt of a user request for the CPU use setting mode, the power manager 103 proceeds to step 227. Otherwise, the power manager 103 goes to step 255 (FIG. 2A).

The power manager 103 displays a screen for the CPU use setting mode in step 227 and proceeds to step 229. The CPU use setting mode screen may include icons or characters representing one or more pre-determined conditions (e.g., a high-performance mode, a normal mode, a low-power mode, and a user setting mode).

In step 229, the power manager 103 determines a user-selected mode from among the pre-determined modes (e.g., high-performance mode, the normal mode, the low-power mode, and the user setting mode). Upon receipt of a user request for the high-performance mode, for example, the power manager 103 goes to step 231. Otherwise, the power manager 103 goes to step 233.

The power manager 103 sets the CPU to the high-performance mode that maximizes the power consumption of the CPU in step 231 and proceeds to step 253. Specifically, the power manager 103 in the high performance mode turns on all CPU cores and changes the CPU clock frequency to a highest frequency. For example, if the CPU includes four cores and a highest CPU clock frequency is 400 MHz, the power manager 103 may turn on all of the four CPU cores and change the current CPU clock frequency to 400 MHz.

Returning to step 229, if the high performance mode is not requested, then processing proceeds to step 233, where the power manager 103 determines whether the user has requested the normal mode from among the pre-determined modes. Upon receipt of a user request for the normal mode, the power manager 103 proceeds to step 235. Otherwise, the power manager 103 proceeds to step 237.

The power manager 103 sets the CPU to the normal mode in step 235 and goes to step 253. Specifically, the power manager 103 turns on a pre-determined number of the CPU cores, for example, half of the CPU cores and turns off the other CPU cores. For example, if the CPU includes four cores, the power manager 103 may turn on two CPU cores and turn off the other two CPU cores.

Returning to step 233, if the normal mode is not requested, then processing proceeds to step 237, where the power manager 103 determines whether the user has requested the low-power mode from among the pre-determined modes. Upon receipt of a user request for the low-power mode, the power manager 103 proceeds to step 239. Otherwise, the power manager 103 proceeds to step 241.

In step 239, the power manager sets the CPU to the low-power mode and goes to step 253. For example, the power manager 103 may turn-on only one of the CPU cores and change the CPU clock frequency to a lowest frequency. For example, if the CPU includes four cores and a lowest CPU clock frequency is 200 MHz, the power manager 103 may turn-on one CPU core, while turning off the other three CPU cores and may change the current CPU clock frequency to 200 MHz.

Returning to step 237, if the low power mode is not selected, then processing proceeds to step 241 where the power manager 103 determines whether the user has requested the user setting mode from among the pre-determined modes. Upon receipt of a user request for the user setting mode, the power manager 103 proceeds to step 243. Otherwise, the power manager 103 proceeds to step 253.

The power manager 103 displays a screen for the user setting mode in step 243 and proceeds to step 245. The user setting mode screen is used for the user to set the CPU based on his or her own desired settings and displays the current states of the respective CPU cores.

In step 245, the power manager 103 determines whether the user has requested a turn-on or a turn-off of a specific CPU core or a change of the CPU clock frequency. Upon receipt of a user request for a turn-on or a turn-off of a selected CPU core, the power manager 103 proceeds to step 247. Otherwise, the power manager 103 proceeds to step 249 (FIG. 2C). The power manager 103 turns on or turns off a user-selected CPU core from among CPU cores displayed on the user setting mode screen in step 247 and proceeds to step 253.

On the other hand, if the power manager 103 determines that the user has requested changing of the CPU clock frequency in step 245, processing proceeds to step 249. If the user has requested changing of the CPU clock frequency, the power manager 103 goes to step 251, where the power manager 103 changes the CPU clock frequency according to the user request and proceeds to step 253. Otherwise, the power manager 103 goes to step 253.

In step 253, the power manager 103 determines whether the user has requested termination of the selected mode. Upon receipt of a user request for termination of the selected mode, the power manager 103 proceeds to step 255. Otherwise, the power manager 103 proceeds to step 227.

The power manager 103 ends the power management function in step 255 and proceeds to step 257. When the power management function ends, the power manager 103 continues execution of an on-going application according to the current CPU setting state. Upon receipt of a user request for executing an application at a later time, the power manager 103 executes the application according to the current CPU setting state.

The power manager 103 monitors power consumption according to the current CPU setting state and stores information about the monitored power consumption in a database in step 257. Upon receipt of a user request for outputting a power consumption monitoring result, the power manager 103 displays the power consumption recorded in the database as a graph, for example, on display 105.

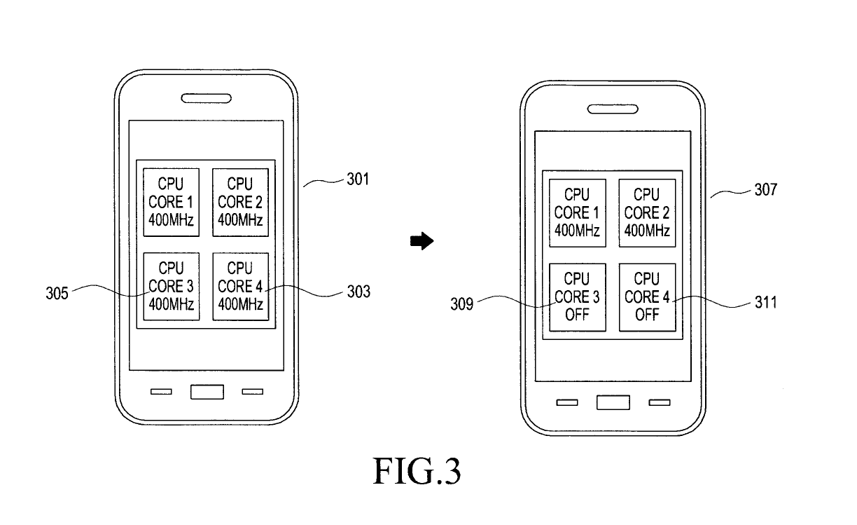

FIG. 3 illustrates a power management screen in the portable terminal according to an embodiment of the present invention.

Referring to FIG. 3, reference numeral 301 denotes a CPU core setting mode screen indicating the current state of CPU cores and reference numeral 307 denotes a screen indicating the state of the CPU cores after user-requested CPU cores are turned off. The screen 301 indicates that first to fourth CPU cores (CPU core 1 to CPU core 4) are in an on-state and the current CPU clock frequency is 400 MHz. The screen 307 indicates that the first and second CPU cores are in the on-state, the third and fourth CPU cores are in off-state, and the current CPU clock frequency is 400 MHz.

Upon receipt of a user request for the CPU core setting mode, the portable terminal displays the screen 301. The screen 301 includes sub-screens indicating the on-state of the first and second CPU cores, a sub-screen 305 indicating the on-state of the third CPU core, and a sub-screen 303 indicating the on-state of the fourth CPU core.

If the user requests turn-off of the third and four CPU cores on the screen 301, the portable terminal turns off the third and fourth CPU cores and displays the screen 307. When the user touches the sub-screens 305 and 303 for the third and fourth CPU cores on the screen 301, the portable terminal determines that a user request for turning off the third and fourth CPU cores has been received.

The screen 307 includes a sub-screen 309 indicating the off-state of the third CPU core, a sub-screen 311 indicating the off-state of the fourth CPU core, and sub-screens indicating the on-state of the first and second CPU cores.

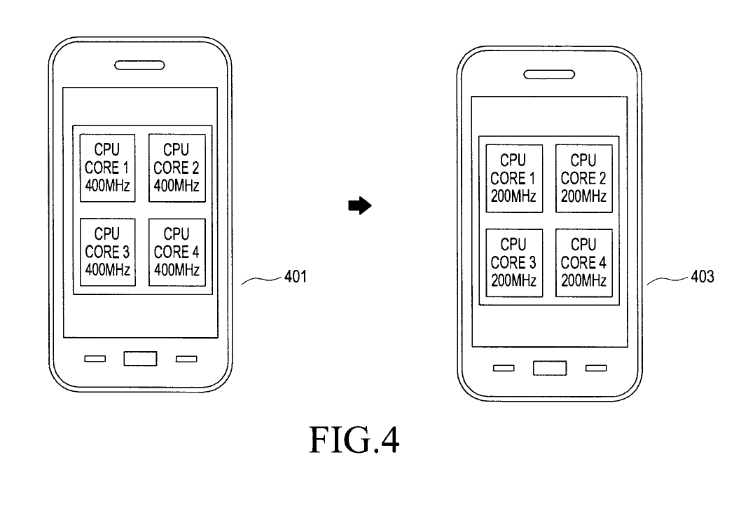

FIG. 4 illustrates a power management screen in the portable terminal according to another embodiment of the present invention.

Referring to FIG. 4, reference numeral 401 denotes a CPU core setting mode screen indicating the current state of the CPU cores and reference numeral 403 denotes a screen indicating the state of the CPU cores after a CPU clock frequency is changed to a user-requested frequency. The screen 401 indicates that the first to fourth CPU cores are in the on-state and the current CPU clock frequency is 400 MHz, whereas screen 403 indicates that the first to fourth CPU cores are in the on-state and the current CPU clock frequency is 200 MHz.

Upon receipt of a user request for the CPU clock setting mode, the portable terminal displays screen 401. Screen 401 includes sub-screens indicating that the first to fourth CPU cores are in the on-state and the current CPU clock frequency is set to 400 MHz.

If the user requests changing the CPU clock frequency from 400 MHz to 200 MHz on the screen 401, the portable terminal displays screen 403. The screen 403 includes sub-screens indicating that the first to fourth CPU cores are in the on-state and the current CPU clock frequency is set to 200 MHz.

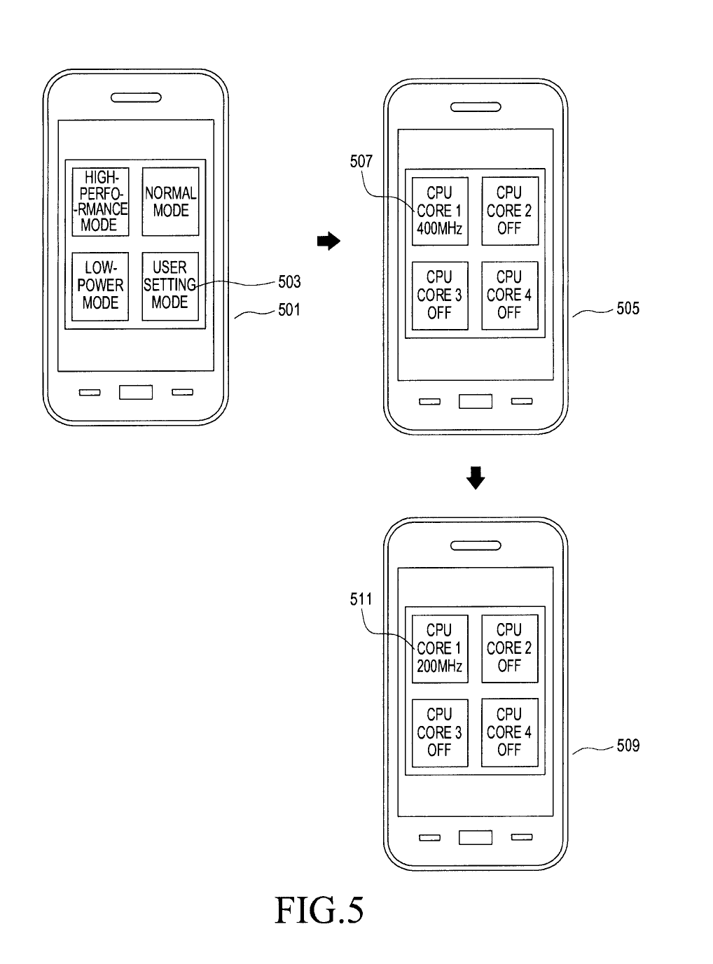

FIG. 5 illustrates a power management screen in the portable terminal according to a further embodiment of the present invention.

Referring to FIG. 5, reference numeral 501 denotes a CPU use setting mode screen, reference numeral 503 denotes a user setting mode screen displayed after the user setting mode is requested, and reference numeral 505 denotes a screen indicating the states of the CPU cores after the CPU clock frequency is changed to a user-requested frequency. The screen 505 indicates that the first CPU core is in the on-state, the second, third and fourth CPU cores are in the off-state, and the current CPU clock frequency is set to 400 MHz. The screen 509 indicates that the first CPU core is in the on-state, the second, third and fourth CPU cores are in the off-state, and the current CPU clock frequency is set to 200 MHz.

Upon receipt of a user request for the CPU use setting mode, the portable terminal displays the screen 501. Upon user selection of the user setting mode on the screen 501, the portable terminal displays the screen 505. The screen 505 includes a sub-screen 507 indicating that the first CPU core is in the on-state and the CPU clock frequency is 400 MHz and sub-screens indicating that the second, third and fourth CPU cores are in the off-state.

When the user requests changing the CPU clock frequency on the screen 505, the portable terminal changes the CPU clock frequency from 400 MHz to 200 MHz and then displays the screen 509. The screen 509 includes a sub-screen 511 indicating that a CPU clock frequency corresponding to the first CPU core is 200 MHz and sub-screens indicate the off-state of the second, third and fourth CPU cores.

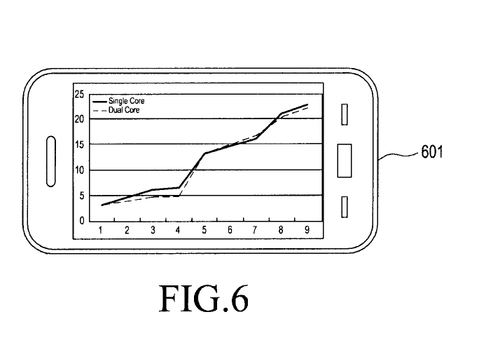

FIG. 6 is a graph illustrating the power consumption of the portable terminal according to an embodiment of the present invention.

Referring to FIG. 6, a graph 601 illustrates power consumption over time, when the portable terminal operates using a single core selected from among the cores of the CPU and when the portable terminal operates using dual cores selected from among the cores of the CPU.

The X axis represents time in units of an hour and the Y axis represents power in units of dBm which is a dB scale.

When the user requests output of power consumption results, the portable terminal may display the graph 601.

As is apparent from the above description of the present invention, the power of a CPU can be managed by allowing a user to set the CPU based on the user's desired operating conditions.

As the user directly turns on or off processing cores includes in the CPUs, the power of the CPU can be managed.

Further, the power of the CPU can be managed by allowing the user to directly change a clock frequency of the CPU.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. An apparatus for managing power in a portable terminal, comprising:
a display; and
a power manager to:
manage power of a Central Processing Unit (CPU) according to a user request, and
set the CPU to a setting mode selected by a user from a group of setting modes, said setting modes comprising one of:
a CPU core setting mode for setting turn-on or turn-off of at least one core included in the CPU,
a CPU clock setting mode for setting a clock frequency of the CPU, and
a CPU use setting mode for setting the CPU to one of a plurality of pre-determined modes.

2. The apparatus of claim 1, wherein upon receipt of a user request for the CPU core setting mode, the power manager:
displays a current state of at least one core of the CPU; and
sets a selected core to one of: an on-state and an off-state, upon user selection of the core from among the displayed at least one core.

3. The apparatus of claim 1, wherein upon receipt of a user request for the CPU clock setting mode, the power manager:
displays a current state of at least one core of the CPU; and
changes the clock frequency of the CPU in response to a user selection of a core from among the displayed at least one core.

4. The apparatus of claim 1, wherein upon receipt of a user request for the CPU use setting mode, the power manager:
displays at least one pre-determined mode, wherein the pre-determined mode is selected from a group consisting of: a high-performance mode for maximizing power consumption of the CPU, a low-power mode for minimizing power consumption of the CPU, a normal mode for keeping the power consumption of the CPU at a normal level, and a user setting mode for allowing a user to set the CPU, and
sets the CPU to a mode selected by the user from among the at least one displayed pre-determined modes.

5. The apparatus of claim 4, wherein when the high-performance mode is selected, the power manager sets all cores included in the CPU to an on-state and sets the clock frequency of the CPU to a highest clock frequency.

6. The apparatus of claim 4, wherein when the low-power mode is selected, the power manager sets only one core included in the CPU to an on-state and sets the clock frequency of the CPU to a lowest clock frequency.

7. The apparatus of claim 4, wherein when the normal mode is selected, the power manager sets a pre-determined number of cores included in the CPU to an on state.

8. The apparatus of claim 4, wherein when the user setting mode is selected, the power manager:
displays a current state of all cores included in the CPU; and
sets at least one selected one of the cores to one of: an on-state and an off-state, upon receipt of a user request for turn-on or turn-off of the at least one selected one of the cores.

9. The apparatus of claim 8, wherein if the user requests changing of the clock frequency of the selected at least one core, the power manager changes the clock frequency of the CPU.

10. The apparatus of claim 1, wherein the power manager executes an application using the CPU mode selected by the user.

11. A method for managing power in a portable terminal, comprising:
determining whether a power management function for managing power of a Central Processing Unit (CPU) is executed according to a user request; and
setting, upon execution of the power management function, the CPU to a setting mode selected by a user selected from a group consisting of: a CPU core setting mode for turning-on or turning-off of at least one core included in the CPU, a CPU clock setting mode for setting a clock frequency of the CPU, and a CPU use setting mode for setting the CPU to one of a plurality of pre-determined modes.

12. The method of claim 11, wherein the CPU setting comprises:
displaying, upon receipt of a user request for the CPU core setting mode, a current state of at least one core of the CPU; and
setting, upon user selection of a core from among the displayed at least one core, the selected core to one of: an on-state and an off-state.

13. The method of claim 11, wherein the CPU setting comprises:
displaying a current state of at least one core of the CPU, upon receipt of a user request for the CPU clock setting mode; and
changing the clock frequency of the CPU, upon user selection of a core from among the displayed at least one core.

14. The method of claim 11, wherein the CPU setting comprises:
displaying, upon receipt of a user request for the CPU use setting mode, a high-performance mode for maximizing power consumption of the CPU, a low-power mode for minimizing the power consumption of the CPU, a normal mode for keeping the power consumption of the CPU at a normal level, and a user setting mode for allowing a user to set the CPU; and
setting the CPU to a mode selected by the user from among the high-performance mode, the low-power mode, the normal mode, and the user setting mode.

15. The method of claim 14, wherein the CPU setting comprises setting all cores included in the CPU to an on-state and setting the clock frequency of the CPU to a highest clock frequency, when the high-performance mode is selected.

16. The method of claim 14, wherein the CPU setting comprises setting only one core included in the CPU to the on-state and setting the clock frequency of the CPU to a lowest clock frequency, when the low-power mode is selected.

17. The method of claim 14, wherein the CPU setting comprises setting a pre-determined number of cores included in the CPU to the on-state, when the normal mode is selected.

18. The method of claim 14, wherein the CPU setting comprises:
displaying a current state of all cores included in the CPU, when the user setting mode is selected; and
setting at least one core to one of the on-state and the off-state, upon receipt of a user request for turning-on or turning-off, respectively, the at least one core.

19. The method of claim 18, wherein the CPU setting further comprises changing the clock frequency of the CPU, if the user requests changing of the clock frequency of the at least one core.

20. The method of claim 11, further comprising executing an application using the CPU setting mode selected by the user.
